(19) United States
(12) Patent Application Publication
(10) Pub. No.: US 2008/0151539 A1
(43) Pub. Date: Jun. 26, 2008

(54) INDICATOR LIGHT DEVICE

(76) Inventors: Hung-Lin LEE, Hsinchu (TW); Chun-Ping WANG, Hsinchu (TW); Jiun-Shiun WANG, Hsinchu (TW)

Correspondence Address: OSTROLENK FABER GERB & SOFFEN, 1180 AVENUE OF THE AMERICAS, NEW YORK, NY, 100368403, US

(21) Appl. No.: 11/843,697

(22) Filed: Aug. 23, 2007

(30) Foreign Application Priority Data
Dec. 26, 2006 (TW) 095148954

(51) Int. Cl. F21V 8/00; F21V 9/08

(52) U.S. Cl. 362/231; 362/240

(57) ABSTRACT

An indicator light device includes a circuit board, at least two light-emitting components, a light-guiding plate, and a housing. The light-emitting components are disposed on the circuit board and are spaced apart from each other. The light-guiding plate includes a plate body disposed on the circuit board, and at least two light-guiding members extending from the plate body in a direction away from the circuit board and corresponding respectively in position to the light-emitting components. The plate body has a surface adjacent to the circuit board and formed with at least one groove that is disposed between the light-guiding members and that defines a fluid space for receiving a fluid transmission medium. The housing is formed with at least two through holes, and is disposed on the plate body of the light-guiding plate such that the light-guiding members respectively extend into the through holes.

### CROSS-REFERENCE TO RELATED APPLICATION

This application claims priority of Taiwanese Application No. 095148954, filed on Dec. 26, 2006.

### BACKGROUND OF THE INVENTION

1. Field of the Invention

The invention relates to an indicator light device, more particularly to an indicator light device including indicator lights that do not interfere with each other.

2. Description of the Related Art

Indicator lights of electronic products are usually disposed very close to one another due to appearance or spatial design requirements thereof, resulting in interference among the various indicator lights. For instance, when a “device power supply” indicator light is lit, and when an adjacent “device malfunction” indicator light does not need to be lit, light emitted by the “device power supply” indicator light travels through to the “device malfunction” indicator light such that the “device malfunction” indicator light appears to be lit as well. This is referred to as interference between the device power supply” and “device malfunction” indicator lights, leading to false indications. Currently, there are two methods for solving the interference problem among indicator lights, and these methods are described in the following paragraphs.

As shown in FIG. 1 and FIG. 2, a first conventional method for solving the interference problem among indicator lights involves providing light-blocking walls 112 that are opaque, that extend downwardly from a housing 111, and that are respectively disposed between adjacent pairs of light-emitting diodes (LEDs) 113 so as to separate the light-emitting diodes 113 in each adjacent pair from each other. It should be noted herein that FIG. 2 is a bottom view of the housing 111 shown in FIG. 1. With the presence of the light-blocking walls 112, the light emitted by each light-emitting diode 113 is confined to travel only through a corresponding light-guiding member 114, and not through other light-guiding members 114.

The light-blocking walls 112 are usually formed directly on the housing 111 by injection molding. However, since injection molding imposes a restriction on the resultant plastic thickness, which is not less than 1 mm, injection molding is not applicable to form extremely thin light-blocking walls 112. On the other hand, injection molding is also not suitable to form extremely thick light-blocking walls 112. This is because it takes a shorter amount of time for an outer portion of the light-blocking wall 112 to harden than that for an inner portion of the light-blocking wall 112 such that the plastic forming the inner portion of the light-blocking wall 112 collapses when the outer portion is completely hardened, resulting in a deformed light-blocking wall 112. Consequently, when it is desired to form a thick light-blocking wall 112, injection molding cannot be used. Instead, a thick light-blocking wall 112 is formed by providing an outer component around a plastic core having a thickness achievable by injection molding so as to achieve the desired thickness. However, this increases both the production cost and assembly time of the indicator light device. As shown in FIG. 3, a second conventional method for solving the interference problem among indicator lights involves mounting the light-emitting diodes 121 from an underside of a circuit board 122 such that the light-emitting diodes 121 are received respectively in through holes 123 formed in the circuit board 122 so as to ensure that the light-emitting diodes 121 do not protrude from a top surface of the circuit board 122. This way, light beams emitted by each of the light-emitting diodes 121 with relatively large incident angles are blocked by the circuit board 122 and cannot penetrate into light-guiding members 124 adjacent to its corresponding light-guiding member 124. However, since tin paste (not shown) is the only means for holding the light-emitting diodes 121 to the circuit board 122, the light-emitting diodes 121 may easily break away from the circuit board 122 during transport.

### SUMMARY OF THE INVENTION

Therefore, the object of the present invention is to provide an indicator light device that is capable of preventing the interference problem among indicator lights, and that is relatively simple to manufacture as compared to the prior art.

According to the present invention, an indicator light device is provided and includes a circuit board, at least two light-emitting components, a light-guiding plate, and a housing. The light-emitting components are disposed on the circuit board and are spaced apart from each other. The light-guiding plate includes a plate body disposed on the circuit board, and at least two light-guiding members extending from the plate body in a direction away from the circuit board and corresponding respectively in position to the light-emitting components. The plate body has a surface adjacent to the circuit board and formed with at least one groove that is disposed between the light-guiding members and that defines a fluid space for receiving a fluid transmission medium. The housing is formed with at least two through holes, and is disposed on the plate body of the light-guiding plate such that the light-guiding members respectively extend into the through holes.

The advantages and effects of the present invention lie in that a groove is formed in the plate body, and that the groove is disposed between the light-guiding members. Consequently, when an interface that defines and surrounds the groove is light transmissive, a portion of the light emitted by the light-emitting components will travel towards the corresponding light-guiding members, while another portion of the light will travel away from the corresponding light-guiding members as this portion of the light is refracted by the interface into the groove due to the difference in refractive indices between the plate body and the fluid transmission medium received in the fluid space that is defined by the groove. On the other hand, when the interface is opaque, the portion of the light emitted by the light-emitting components and traveling away from the corresponding light-guiding members cannot pass through the interface such that this portion of the light is prevented from entering into the light-guiding members other than the corresponding light-guiding members. Therefore, it is only necessary to form the groove during injection molding of the light-guiding plate in order to prevent the light emitted by the light-emitting components from entering into the light-guiding members other than the corresponding light-guiding members and leading to false indications. As a result, the present invention uses an easy manufacturing process to achieve the object of preventing the interference problem among indicator lights. Other objectives, features and advantages of the present invention will be further understood from the further technological features disclosed by the embodiment of the present invention wherein there is shown and described a preferred embodiment of this invention, simply by way of illustration of modes best suited to carry out the invention.

### BRIEF DESCRIPTION OF THE DRAWINGS

FIG. 1 is a fragmentary sectional view of a conventional indicator light device utilizing a first conventional method for solving the interference problem among indicator lights;

FIG. 2 is a bottom schematic view of a housing of the conventional indicator light device of FIG. 1;

FIG. 3 is a fragmentary sectional view of another conventional indicator light device utilizing a second conventional method for solving the interference problem among indicator lights;

FIG. 4 is an exploded top schematic view of the preferred embodiment of an indicator light device according to the present invention;

FIG. 5 is a top schematic view of a light-guiding plate of the preferred embodiment;

FIG. 6 is a fragmentary sectional view of the preferred embodiment; and

FIG. 7 is a top schematic view of a circuit board of the preferred embodiment.

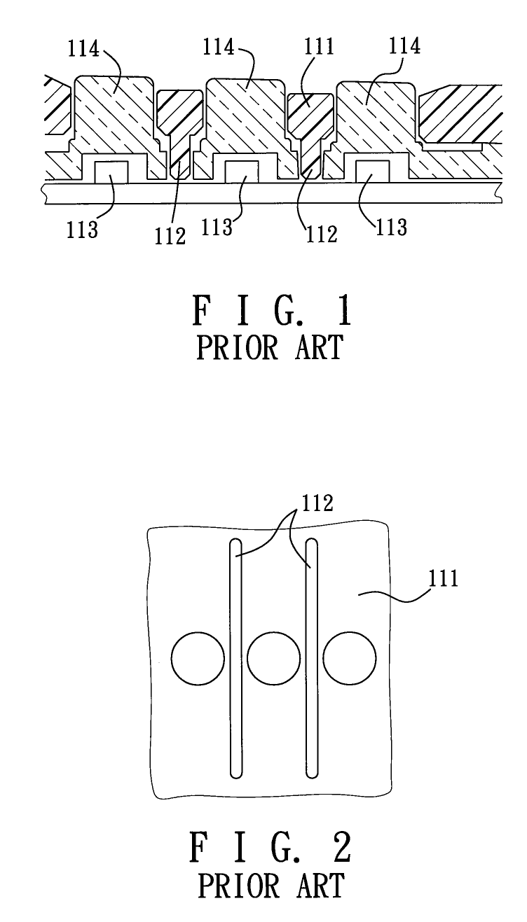

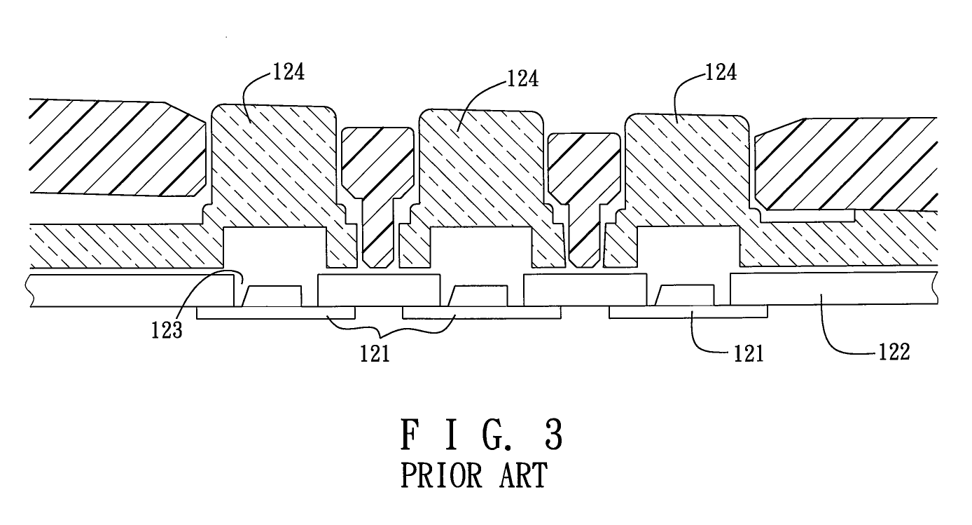

### DETAILED DESCRIPTION OF THE PREFERRED EMBODIMENT

In the following detailed description of the preferred embodiment, reference is made to the accompanying drawings which form a part hereof, and in which is shown by way of illustration a specific embodiment in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

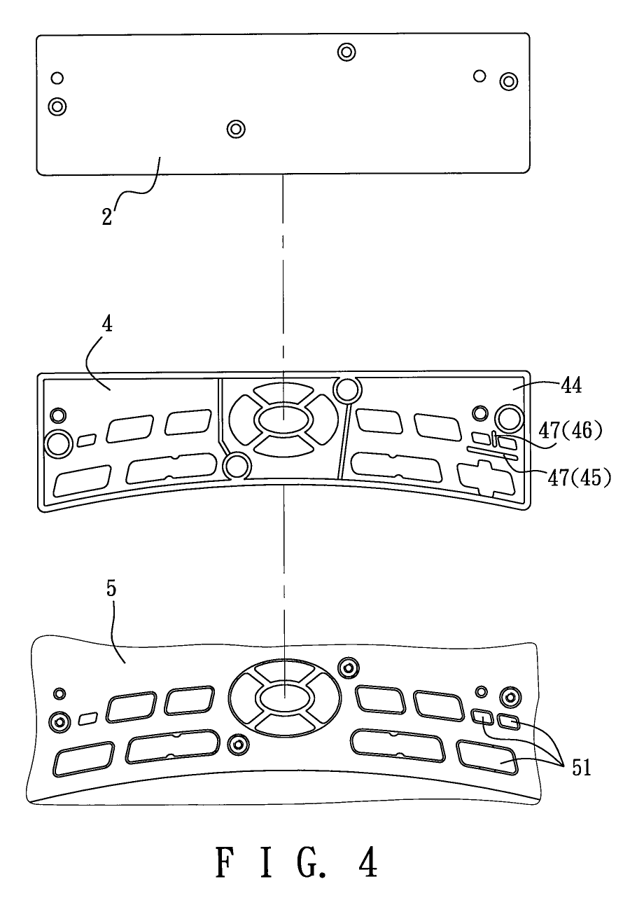

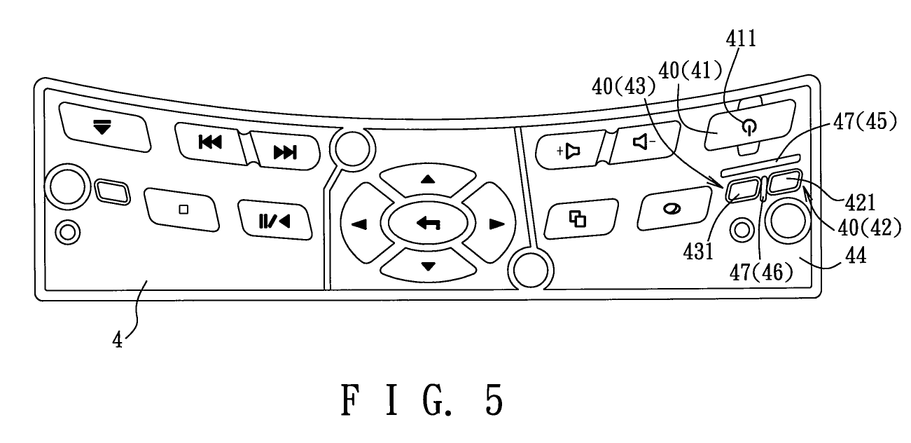

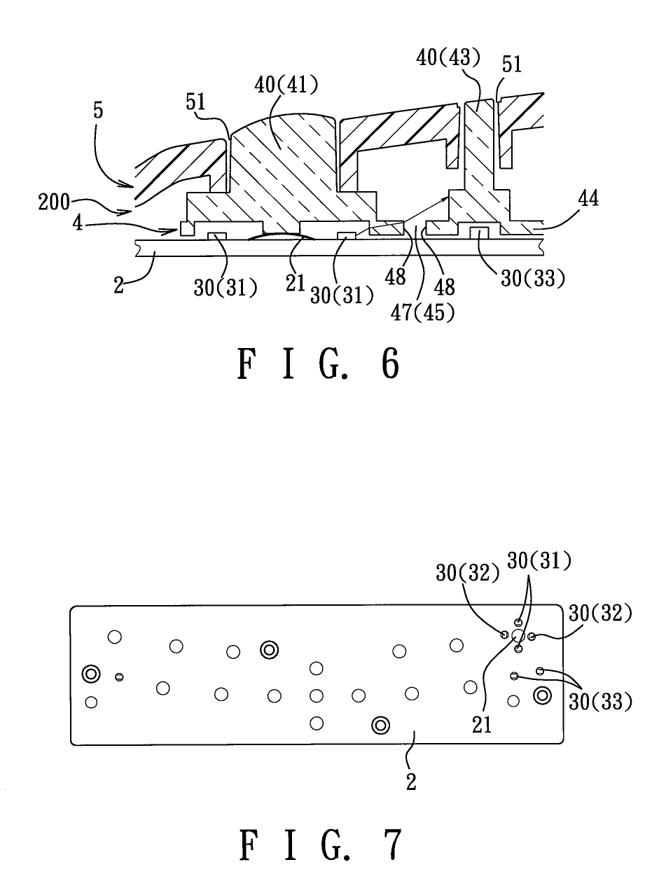

As shown in FIG. 4, FIG. 5 and FIG. 6, an indicator light device 200 according to a preferred embodiment of the present invention includes a circuit board 2, at least two light-emitting components 30, a light-guiding plate 4, and a housing 5.

The light-emitting components 30 are disposed on the circuit board 2 and are spaced apart from each other. The light-guiding plate 4 includes a plate body 44 disposed on the circuit board 2, and at least two light-guiding members 40 extending from the plate body 44 in a direction away from the circuit board 2 and corresponding respectively in position to the light-emitting components 30. The plate body 44 has a surface adjacent to the circuit board 2 and formed with at least one groove 47 which is disposed between the light-guiding members 40 and which defines a fluid space for receiving a fluid transmission medium. In this embodiment, the fluid transmission medium is air.

The housing 5 is formed with at least two through holes 51, and is disposed on the plate body 44 of the light-guiding plate 4 such that the light-guiding members 40 respectively extend into the through holes 51. The housing 5 has a portion disposed above the groove 47 and in a form of a plate.

In this embodiment, the indicator light device 200 is applied to a projector, and includes the circuit board 2, six of the light-emitting components 30, the light-guiding plate 4, and the housing 5. Referring to FIG. 7, the six light-emitting components 30 include first and second light-emitting components 31, third and fourth light-emitting components 32, and fifth and sixth light-emitting components 33.

As shown in FIG. 7, a resilient metal dome 21 is provided and is disposed in releasable electrical connection with the circuit board 2, where the resilient metal dome 21 is in electrical connection with the circuit board 2 when it is pressed.

In this embodiment, the first to the sixth light-emitting components 31, 32, 33 are disposed on the circuit board 2 and are spaced apart from each other. The first, second, third and fourth light-emitting components 31, 32 are disposed at corners of a square surrounding the resilient metal dome 21. In this embodiment, each of the light-emitting components 30 is a light-emitting diode (LED), but is not limited thereto in other embodiments of the present invention.

Referring back to FIG. 5 and FIG. 6, the light-guiding plate 4 includes the plate body 44 and three of the light-guiding members 40, and is formed with two of the grooves 47. The light-guiding members 40 include a first light-guiding member 41, a second light-guiding member 42, and a third light-guiding member 43, and the grooves 47 include a first groove 45, and a second groove 46. Each of the first, second and third light-guiding members 41, 42, 43 includes a light transmissive portion 411, 421, 431 disposed distal from the plate body 44. The plate body 44 is disposed on the circuit board 2, and the first, second and third light-guiding members 41, 42, 43 extend from the plate body 44 in a direction away from the circuit board 2. The light transmissive portions 411, 421, 431 are disposed at a top surface of the corresponding one of the first, second, and third light-guiding members 41, 42, 43. In this embodiment, the first and second grooves 45, 46 extend through a first surface of the plate body 44 distant from the circuit board 2, and a second surface of the plate body 44 adjacent to the circuit board 2. As shown in FIG. 5, FIG. 6 and FIG. 7, the first groove 45 is disposed between the first light-guiding member 41 and the second and third light-guiding members 42, 43. The second groove 46 is disposed between the second and third light-guiding members 42, 43. The first, second, third and fourth light-emitting components 31, 32 are disposed to correspond in position to the first light-guiding member 41. The first and second light-emitting components 31 are capable of emitting light with a first color, and are disposed on opposite first sides of the resilient metal dome 21. The third and fourth light-emitting components 32 are capable of emitting light with a second color different from the first color, and are disposed on opposite second sides of the resilient metal dome 21. The first and second sides substantially define a square surrounding the resilient metal dome 21.

The fifth and sixth light-emitting components 33 are disposed to correspond in position to the second and third light-guiding members 42, 43, respectively.

Therefore, in this embodiment, the first light-guiding member 41 cooperates with the first, second, third and fourth light-emitting components 31, 32, and a corresponding portion of the plate body 44 from which the first light-guiding member 41 extends to form a “power supply and standby mode” indicator light of the indicator light device 200. The first and second light-emitting components 31 emit light with the first color when the projector operates in a standby mode. The third and fourth light-emitting components 32 emit light with the second color when the first light-guiding member 41 is pressed such that the resilient metal dome 21 is pressed to turn on the projector in order to provide indication that the projector is turned on. The second light-guiding member 42 cooperates with the fifth light-emitting component 33 and a corresponding portion of the plate body 44 from which the second light-guiding member 42 extends to form a first “malfunctioning” indicator light of the indicator light device 200, while the third light-guiding member 43 cooperates with the sixth light-emitting component 33 and a corresponding portion of the plate body 44 from which the third light-guiding member 43 extends to form a second “malfunctioning” indicator light of the indicator light device 200. For example, when the light source of the projector is not operating properly, or when temperature of the projector is too high, one of the first and second “malfunctioning” indicator lights will be lit. However, the designated indications of the indicator lights are not limited to those disclosed hereinabove. For instance, the first light-guiding member 41 cooperates with the first, second, third and fourth light-emitting components 31, 32 and the corresponding portion of the plate body 44 from which the first light-guiding member 41 extends to form a single “power supply” indicator light or a single “standby mode” indicator light of the indicator light device 200. In other words, in other embodiments of the present invention, it is not necessary to incorporate two indicator lights into one as in this embodiment.

In order for light emitted by the first, second, third, fourth, fifth and sixth light-emitting components 31, 32, 33 to pass only through the light transmissive portion 411, 421, 431 of the corresponding first, second and third light-guiding members 41, 42, 43, the light-guiding plate 4 further includes a layer of paint applied on portions of the first, second and third light-guiding members 41, 42, 43 other than the light transmissive portions 411, 421, 431 and on surfaces of the plate body 44 other than the surface adjacent to the circuit board 2. The color of the paint is chosen as required by the appearance design of the indicator light device 200, but is preferably black. There are two ways of applying the paint. One way of applying the paint is by spraying paint on all portions of the first, second and third light-guiding members 41, 42, 43, and on surfaces of the plate body 44 other than the surface adjacent to the circuit board 2, followed by removing the paint on the light transmissive portions 411, 421, 431 by laser engraving. The other way of applying the paint is by mask spraying, where the light transmissive portions 411, 421, 431 are covered up before the paint is sprayed onto the portions where paint is necessary, and then the covers are then removed to reveal the paint-free light transmissive portions 411, 421, 431.

In this embodiment, the plate body 44 and the first, second and third light-guiding members 41, 42, 43 of the light-guiding plate 4 are made integrally by injection molding a rubber material. The rubber material may also be replaced with a light transmissive plastic material, such as polymethyl methacrylate (PMMA).

As shown in FIG. 4 and FIG. 6, the housing 5 is formed with three of the through holes 51, and is disposed on the plate body 44 of the light-guiding plate 4 such that the first, second and third light-guiding members 41, 42, 43 respectively extend into the through holes 51. In addition, the housing 5 has a portion disposed above the first and second grooves 45, 46 and in a form of a plate. During assembly, the circuit board 2 and the housing 5 are coupled together, and the light-guiding plate 4 is clamped between the circuit board 2 and the housing 5.

In this embodiment, the plate body 44 has interfaces 48, which respectively define and surround the first and second grooves 45, 46. The interfaces 48 are light transmissive or opaque. When the interfaces 48 are light transmissive, the portion of the light emitted by the light-emitting components 31, 32, 33 and traveling away from the corresponding first, second and third light-guiding members 41, 42, 43 is refracted into the first and second grooves 45, 46 due to the difference in refractive indices between the plate body 44 and the fluid transmission medium contained in the fluid spaces defined respectively by the first and second grooves 45, 46. Since the refractive index of the plate body 44 is greater than air, which is the fluid transmission medium in this embodiment, the refractive angle is greater than the incident angle when the incident angle is non-zero. Consequently, the portion of the light refracted into the first and second grooves 45, 46 is dispersed toward the surfaces of the plate body 44, where the paint is applied, or toward the circuit board 2. This way, the light emitted by the light-emitting components 31, 32, 33 are prevented from entering into the light-guiding members 41, 42, 43 other than the corresponding light-guiding members 41, 42, 43.

When the interfaces 48 are applied with a layer of paint so as to be opaque, the portion of the light emitted by the light-emitting components 31, 32, 33 and traveling away from the corresponding first, second and third light-guiding members 41, 42, 43 cannot pass through the interfaces 48 due to the layer of paint applied thereon such that this portion of the light is prevented from entering into the light-guiding members 41, 42, 43 other than the corresponding light-guiding members 41, 42, 43.

Referring again to FIG. 5, FIG. 6 and FIG. 7, the effect of the present invention on solving the “interference” problem is confirmed through an optical simulation software called ASAP and developed by Breault Research Organization. In the simulation, the first, second, third and fourth light-emitting components 31, 32 corresponding to the first light-guiding member 41 are lit, while the fifth and sixth light-emitting components 33 are not lit such that theoretically, no light should travel through the second and third light-guiding members 42, 43. Therefore, by comparing the total number of light beams traveling through the second and third light-guiding members 42, 43 for the embodiment of the present invention and for the prior art, the advantage and effect of the present invention is confirmed.

The conditions of the simulations are as follows: The first, second and third light-guiding members 41, 42, 43 and the plate body 44 of the light-guiding plate 4 are made from PMMA, whose refractive index is 1.49, while the refractive index of air is equal to 1. The plate body 44 of Simulation A is not formed with the first and second grooves 45, 46 to represent implementation of the prior art. The plate body 44 of Simulation B is formed with the first and second grooves 45, 46, and has light transmissive interfaces 48. The plate body 44 of Simulation C is formed with the first and second grooves 45, 46, and has opaque interfaces 48.

TABLE 1

| | Number of | | Number of | |
|---|---|---|---|---|
| | Light Beams | | Light Beams | |
| | Traveling | | Traveling | |
| | through the | | through the | |
| | Second | Light | Third | Light |
| | Light-guiding | Intensity | Light-guiding | Intensity |
| | Member 42 | Percentage | Member 43 | Percentage |
| Simulation A | 1725 | 100.00% | 1531 | 100.00% |
| Simulation B | 487 | 28.23% | 261 | 17.05% |
| Simulation C | 102 | 5.91% | 38 | 2.48% |

Table 1 shows the results obtained by the optical simulation software for Simulations A, B and C. Referring to FIG. 5, FIG. 6 and Table 1, it can be seen from the simulation results that in the case where the plate body 44 is not formed with the first and second grooves 45, 46, as in Simulation A, the light intensity percentages at the second light-guiding member 42 and at the third light-guiding member 43 are both 100%. In the case where the plate body 44 is formed with the first and second grooves 45, 46, and the interfaces 48 are light transmissive, as in Simulation B, the light intensity percentage at the second light-guiding member 42 is reduced greatly by 71.77%, while the light intensity percentage at the third light-guiding member 43 is reduced by 82.95%, as compared to Simulation A. In the case where the plate body 44 is formed with the first and second grooves 45, 46, and the interfaces 48 are opaque, as in Simulation C, the light intensity percentage at the second light-guiding member 42 is reduced even further, by a total of 94.09%, while the light intensity percentage at the third light-guiding member 43 is reduced by 97.52%, as compared to Simulation A. Therefore, formation of the first and second grooves 45, 46 in the plate body 44 of the light-guiding plate 4 for defining the fluid spaces can indeed effectively reduce the interference problem with the indicator lights.

In sum, the plate body 44 of the light-guiding plate 4 of the indicator light device 200 according to the present invention is formed with the first and second grooves 45, 46, where the first and second grooves 45, 46 are disposed between corresponding ones of the first, second and third light-guiding members 41, 42, 43 in the manner described hereinabove. In addition, the plate body 44 has the interfaces 48, which respectively define and surround the first and second grooves 45, 46. When the interfaces 48 are light transmissive, the portion of the light emitted by the light-emitting components 31, 32, 33 and traveling away from the corresponding first, second and third light-guiding members 41, 42, 43 is refracted into the first and second grooves 45, 46 due to the difference in refractive indices between the plate body 44 and the fluid transmission medium contained in the fluid spaces defined respectively by the first and second grooves 45, 46 so as to be dispersed toward the surfaces of the plate body 44 where the paint is applied, or toward the circuit board 2. This way, the light emitted by the light-emitting components 31, 32, 33 are prevented from entering into portions of the light-guiding members 41, 42, 43 other than portions of the corresponding light-guiding members 41, 42, 43. When the interfaces 48 are applied with the layer of paint so as to be opaque, the portion of the light emitted by the light-emitting components 31, 32, 33 and traveling away from the corresponding first, second and third light-guiding members 41, 42, 43 cannot pass through the interfaces 48 due to the layer of paint applied thereon such that this portion of the light is prevented from entering into the light-guiding members 41, 42, 43 other than the corresponding light-guiding members 41, 42, 43. Therefore, the interference problem among the indicator lights of the light indicating device 200 is prevented by simply forming the first and second grooves 45, 46 during injection molding of the plate body 44, which is an easy manufacturing process, thereby achieving the object of the present invention.

The six light-emitting components 30, the three light-guiding members 40, the two grooves 47 and the three through holes 51 of the preferred embodiment are for illustrative purpose only, and should not be construed to limit the scope of the present invention. There can be two light-emitting components 30, two light-guiding members 40, one groove 47 and two through holes 51, or multiple light-emitting components 30, multiple light-guiding members 40, multiple grooves 47 and multiple through holes 51 in other embodiments of the present invention. In addition, according to the present invention, it is not necessary for the grooves 47 to extend through the plate body 44.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An indicator light device comprising:
a circuit board;
at least two light-emitting components disposed on the circuit board and spaced apart from each other;
a light-guiding plate including a plate body disposed on the circuit board, and at least two light-guiding members extending from the plate body in a direction away from the circuit board and corresponding respectively in position to the light-emitting components, the plate body having a surface adjacent to the circuit board and formed with at least one groove which is disposed between the light-guiding members and which defines a fluid space for receiving a fluid transmission medium; and
a housing formed with at least two through holes, and disposed on the plate body of the light-guiding plate, the light-guiding members respectively extending into the through holes.

2. The indicator light device as claimed in claim 1, wherein the fluid transmission medium is air.

3. The indicator light device as claimed in claim 1, wherein the housing has a portion disposed above the groove and in a form of a plate.

4. The indicator light device as claimed in claim 1, wherein the groove extends through the plate body in the direction away from the circuit board.

5. The indicator light device as claimed in claim 1, wherein the plate body has a interface which defines and surrounds the groove, and which is light transmissive.

6. The indicator light device as claimed in claim 1, wherein the plate body has an interface which defines and surrounds the groove, and which is opaque.

7. The indicator light device as claimed in claim 6, wherein the light-guiding plate further includes a layer of paint applied on the interface.

8. The indicator light device as claimed in claim 1, wherein each of the light-guiding members includes a light transmissive portion distal from the plate body, the light-guiding plate further including a layer of paint applied on portions of the light-guiding members other than the light transmissive portions and on surfaces of the plate body other than the surface adjacent to the circuit board.

9. The indicator light device as claimed in claim 1, wherein each of the light-guiding members cooperates with the corresponding one of the light-emitting components and a corresponding portion of the plate body from which the light-guiding member extends to form an indicator light of the indicator light device.

10. The indicator light device as claimed in claim 1, wherein each of the light-emitting components is a light-emitting diode.

11. The indicator light device as claimed in claim 1, wherein the light-guiding plate is made from a rubber material.

12. The indicator light device as claimed in claim 1, wherein the light-guiding plate is made from a plastic material.

13. The indicator light device as claimed in claim 12, wherein the light-guiding plate is made from polymethyl methacrylate (PMMA).

14. The indicator light device as claimed in claim 1, wherein the light-guiding plate includes three of the light-guiding members, and is formed with two of the grooves, one of the grooves being disposed between a first one of the light-guiding members and second and third ones of the light-guiding members, the other one of the grooves being disposed between the second and third ones of the light-guiding members.

15. The indicator light device as claimed in claim 14, comprising six of the light-emitting components, first, second, third and fourth ones of the light-emitting components being disposed to correspond in position to the first one of the light-guiding members, the first and second ones of the light-emitting components being capable of emitting light with a first color, the third and fourth ones of the light-emitting components being capable of emitting light with a second color different from the first color, fifth and sixth ones of the light-emitting components being disposed to correspond in position to the second and third ones of the light-guiding members, respectively.

16. The indicator light device as claimed in claim 15, wherein the first one of the light-guiding members cooperates with the first, second, third and fourth ones of the light-emitting components and a corresponding portion of the plate body from which the first one of the light-guiding members extends to form a power supply and standby mode indicator light of the indicator light device.

17. The indicator light device as claimed in claim 15, wherein the second one of the light-guiding members cooperates with the fifth one of the light-emitting components and a corresponding portion of the plate body from which the second one of the light-guiding members extends to form a first malfunctioning indicator light of the indicator light device, and the third one of the light-guiding members cooperates with the sixth one of the light-emitting components and a corresponding portion of the plate body from which the third one of the light-guiding members extends to form a second malfunctioning indicator light of the indicator light device.
